(19) United States
(12) Patent Application Publication
(10) Pub. No.: US 2009/0034738 A1
(43) Pub. Date: Feb. 5, 2009

(54) Method and apparatus for securing layer 2 networks

(76) Inventor: Charles Rodney Starrett, Cary, NC (US)

Correspondence Address: TRIANGLE PATENTS, P.L.L.C., P.O. BOX 28539, RALEIGH, NC, 27611-8539, US

(21) Appl. No.: 11/888,097

(22) Filed: Jul. 31, 2007

(51) Int. Cl. H04L 9/08; G06F 17/00; H04L 9/00

(52) U.S. Cl. 380/278; 380/44; 726/1

(57) ABSTRACT

Systems and methods for using a shared key architecture to enable secure Layer 2 meshed network security.

### BACKGROUND OF THE INVENTION

1. Field of the Invention

The present invention relates generally to providing security on Layer 2 networks. Further, the present invention relates to enabling security features such encryption and packet authentication to function transparently over a Layer 2 network without the need for al network-based hardware.

2. Description of the Prior Art

By way of background, enterprises use metro ethernets to connect a number of offices together. Metro ethernets have also become popular as the primary source of broadband internet connectivity. Such Layer 2 networks enable the service providers to expand the the networks and form groups or subnetworks known as Virtual LANs. A number of nodes are grouped and have a common access point to the main network. This additional hardware introduces restrictions on the type of applications that these nodes can execute. Additionally, enterprises utilizing such networks for their private use may not be able to secure the network completely.

Today, Metro Ethernet networks are providing resilient, high speed and low cost data, voice and video services for both enterprise and home use. Organizations can use metro Ethernet to tie local sites together, to extend LANs, to access the internet—really any network access service. End users may be using metro Ethernet services for voice, data, and video services from their cable provider.

To provide these services, Service Providers depend on a number of network technologies that provide access, data transfer, and customer separation. These technologies include technologies such as IEEE802.1Q, L2 multicast and broadcast, redundant L2 paths for resiliency and Load balancing for sharing bandwidth and resiliency.

Security for these networks is challenging. IEEE 802.1Q (VLAN) tags are used to separate users or enterprises on the network but the data on the network may flow in the clear. If a hacker had the tools and access to the network, the network is totally open to anyone that wants to see or steal the data. Voice and video can be captured and replayed. An organization's intellectual property is at risk as it flows over the shared network unencrypted.

While many of these networks may be meshed networks, i.e., they provide for multiple sites that exchange data in a mesh design, there remains a need for encrypted data exchange over a Layer 2 network.

Current security solutions are completely inadequate to satisfy the stringent requirements as defined by regulations such as HIPAA, Sarbannes-Oxley, and CA Senate Bill 1386. Not only do they not support multicast, broadcast, redundancy, and load balancing applications but they do not scale to support large enterprise networks.

Current solutions to address the problem of Layer 2 security generally rely on layer 3 (router) networks to forward traffic over secure IPSec tunnels. Using Layer 3 devices adds greatly to the complexity of the security and network design. This patent enables a secure Layer 2 mesh without resorting to the use of Layer 3 protocols.

Hence, there is a need for a solution that secures Layer 2 networks, such as metro Ethernets without relying on additional Layer 3 hardware to be present at end points to interpret and relay traffic and packets. The solution should be able to support features such as load balancing, IEEE 802.1QVLAN tagging, redundant paths, and multicasting to enable leveraging the metro Ethernet networks.

### SUMMARY OF THE INVENTION

A first aspect of the present invention is to provide a system for providing secure or encrypted Layer 2 networks comprising a communication network having a network infrastructure, in particular for meshed network configurations; the communication network spread over a geography such that nodes on the network are use Layer 2 networking protocols, such as Ethernet, to communicate, at least one management and policy (MAP) server operable for communication within the network, wherein the MAP includes at least one policy for providing secure associations (SA) within the network; at least one key authority point (KAP); a multiplicity of policy enforcement points (PEPs) having nodes distributed throughout the network; wherein the KAP is operable to generate and manage key(s) communicated to the multiplicity of PEPs; and wherein the multiplicity of PEPs enforce policies for secure communication between the nodes on the network and maintain transparency at Layer 2.

A second aspect of the present invention is to provide a method for providing secure interactivity between points on a Layer 2 network comprising the steps of providing a communication network having a network infrastructure and a secure network topography between a multiplicity of policy enforcement points (PEPs) having nodes with any form of encryption associated therewith; the nodes spread over a wide geographic area such that they form a Layer 2 network such as metro ethernet network; a user providing at least one policy definition to a management and policy (MAP) server in communication with a key authority point (KAP); the KAP generating and distributing encryption and decryption keys to the PEPs consistent with the MAP policy; the PEPs enforcing the policy at the nodes to provide secure communication across the network topography over the Layer 2 network.

The present invention is further directed to a method for forming secure subnetworks in a metro ethernet such that nodes in the subnetworks, which are separated geographically, can communicate securely and transparently without additional hardware and software configuration.

Yet another aspect of the present invention is to provide secure distribution of broadcast and multicast content over metro ethernets.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic showing a centralized software solution for providing and managing security for data and communications of a network in accordance with an embodiment of the present invention.

FIG. 2 is a schematic showing a plurality of PEPs distributed over a metro ethernet network to enable the formation of secure subnetworks, in accordance with an embodiment of the present invention.

FIG. 3 is a schematic showing a plurality of PEPs distributed over a meshed network to enable the formation of secure subnetworks in conjunction with a central service provider, in accordance with an embodiment of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention relates to a system and method for providing secure communication over shared networks, such as metro ethernets and other mesh networks that function on Layer 2 of the OSI network model. End points or nodes within a network system according to the present invention are operable to be grouped in a Layer 2 network into VLANs. In commercial settings, a service provider uses VLANs to segment different customers over the same metro (L2) Ethernet network. Layer 3 hardware induces complex network protocols over the L2 network to separate customer and secure mesh networks are difficult to manage. In addition, multicast is very difficult to implement.

The present invention provides a key and policy management software-based solution that enables secure data access and user interactions, and that enables users to securely access and interact with data they need and are authorized to access on predetermined, regular, and/or transactional bases from any point on the network without requiring changes in the existing infrastructure (noting that policy end points (PEPs) are hardware). The present invention system and method controls and manages the establishment and activity for trusted, secure connections across a network, wherein such connections are created by end point security technologies. This flexible software solution does not require a separate infrastructure to affect changes in network access, key or policy management.

Preferably, the system and methods of the present invention provide a network-independent solution layer or overlay that functions over the existing network infrastructure to control the policies, security associations (SAs), and keys provided by a key authority point (KAP) to a multiplicity of policy enforcement points (PEPs) for enabling secure communications and data access to authorized users at any point within the network to other points, based upon the policies managed and provided by a management and policy server (MAP). Also, the flexible software overlay for MAP and KAP functions within the system provides for dynamic modifications in real time without requiring changes to existing infrastructure or hardware, and without regard to the form of encryption thereon. Therefore, use and implementation of the present invention is not limited to traditional networking or infrastructure and is not limited to a single encryption form or type.

A metro ethernet network includes multiple nodes that are interconnected by multiple network devices and that may be connected in a variety of different network topologies. The nodes include computing devices such as, by way of example and not limitation, laptops, desktops, handheld devices, mobile devices, cable access systems, and other devices capable of connecting to a network, or a network of such devices.

These nodes communicate with each other, or'servers providing services such as web pages, email, voice over internet protocol (VoIP), video broadcasting, multicasting applications, streaming audio or video via unprotected networks. This leaves most of the metro Ethernet and-internet communications open to interception by anyone. This communication is protected by using cryptographic keys. One or more nodes are grouped together so that they communicate over the unprotected networks via one or more policy enforcement points (PEP). The user defines security policy using the MAP. The MAP distributes this policy to one or more KAPs. The KAPs, based on policy, will generate cryptographic keys and distribute policy and keys to each PEP. There are several configurations operable for arranging PEPs and KAPs within a network according to the present invention. By way of example, the system is operable for multiple KAPs, including peer KAPs, for one or more PEPs. Alternatively, the system and methods are functional where there is a single KAP that provides the keys for all the PEPs in a metro ethernet network.

Based on the policies received from the MAP, the universal KAP of the present invention generates one or more cryptographic keys for each of the PEPs, or a single key to be shared by PEPs, within its network as defined by the MAP. The PEPs use the cryptographic keys to encrypt communication from the nodes and networks that they protect to other secured networks that are part of the Layer 2 infrastructure The KAP receives the policy definition from a single MAP. This policy definition informs the KAP about the PEPs it is responsible for, which networks the PEPs protect, and which KAP units they use. The KAP distributes the keys and policies associated with its networks and nodes to the appropriate PEPs.

In an embodiment of the present invention, at least one PEP is connected to each subnetwork that is formed in the metro ethernet network. These PEPs encrypt out going communication, based on policy, with a key that is received from the KAP. After the communication is encrypted, it is transmitted to the destination subnetwork based on Layer 2 addressing policies. The PEPs do not alter the Layer 2 headers in any way allowing the PEPs to function transparently, nor do the end nodes need to be configured in order to route the traffic through the PEPs. Hence nodes on one subnetwork use Layer 2 addressing to transmit data to another node on another subnetwork. The PEPs intercept this data transmission, encrypt the data packet being sent without altering the Layer 2 headers. The PEP at the destination subnetwork receives this encrypted data packet and recognizes that it can decrypt that data packet based on its content. After the payload has been decrypted, the packet is then allowed to pass through to the subnetwork where it is received by the destination node.

The subnetworks in the metro ethernet are separated on the basis of policies defined at the MAP. These policies can be defined by a system administrator or can be automatically setup based on network topology. The policies defined at the MAP determine the subnetworks that are transparently connected such that nodes in one subnetwork can securely communicate with nodes on another subnetwork. In another embodiment, the policies are used to determine the recipients of secure broadcast or multicast content. These policies, defined at the MAP, are transmitted to the KAPs. The KAPs use the policy information to transmit keys to the PEPs. PEPs that are group-based on the policies defined by the MAP may get a common set of keys allowing any PEP to decrypt data encrypted by another PEP. This is the case in broadcast and multicast content. One PEP encrypts the multicast stream with one cryptographic key, while many PEPs may have to decrypt the content using keys shared among the PEPs. Any other combination of keys can be used such that data encrypted by one PEP using one key can be decrypted by another PEP that is allowed to view that data as determined by the MAP policies. The communication of keys between the KAP and the PEPs is also be encrypted and authenticated such that only authorized PEPs can receive the keys.

The present invention provides management techniques or methods and systems to provide secure networks with distributed keys wherein the key sharing and distribution is simplified, i.e., management of key sharing and distribution is handled by a MAP in secure communication with key authority point(s) (KAP) that generate the keys in accordance with communicated MAP policy or policies. The MAPs define the internet protocol (IP) address and name for each policy enforcement point (PEP), both which define the nodes of the network. The MAP then defines network sets, which include the list of networks or IP addresses that are protected by a given set of PEPs; peer KAPs provide for separate distributors for separate networks and corresponding PEPs. The KAP then distributes keys to the authenticated and authorized PEPs or peer KAPs according to the prior step. In one embodiment of the present invention, when two PEPs are protecting the subnet, then the KAP provides the network set to be equivalent to the network.

Preferably the systems and methods of the present invention are applicable and operable over existing network management schemes without requiring a change in the hardware or network configuration.

In a particular embodiment as applied to IPSec, grouping of PEPs and KAPs in networks is protected, wherein the grouping is considered one entity that can be used in the policy. This provides for key sharing for multiple paths on PEPs and key distributors according to the present invention. This support for KAP and multiple PEPs provides for automatic predetermination of the configuration of the secure network.

The present invention provides a simplifying method to configure security settings for networks and subnets. The policy enforcement points (PEPs) protect the nodes and provide security across the network and nodes using keys for security authorization and for encryption/decryption that are provided to the PEPs by the KAP, directly or indirectly.

As discussed above, the PEPs do not alter Layer 2 headers on data packets. Additionally, the PEPs are transparent at Layer 2. This means that devices on the subnetworks do not need to be configured to enable them to function with the system of the current invention. The PEPs act as transparent intermediaries in the subnetworks. ARP requests are forwarded in plain text to the subnetwork. However, other communication is encrypted by the PEPs. The PEPs only encrypt the L2 payload data while Layer 2 packets are not altered. In this way, communication is secure as well as transparent.

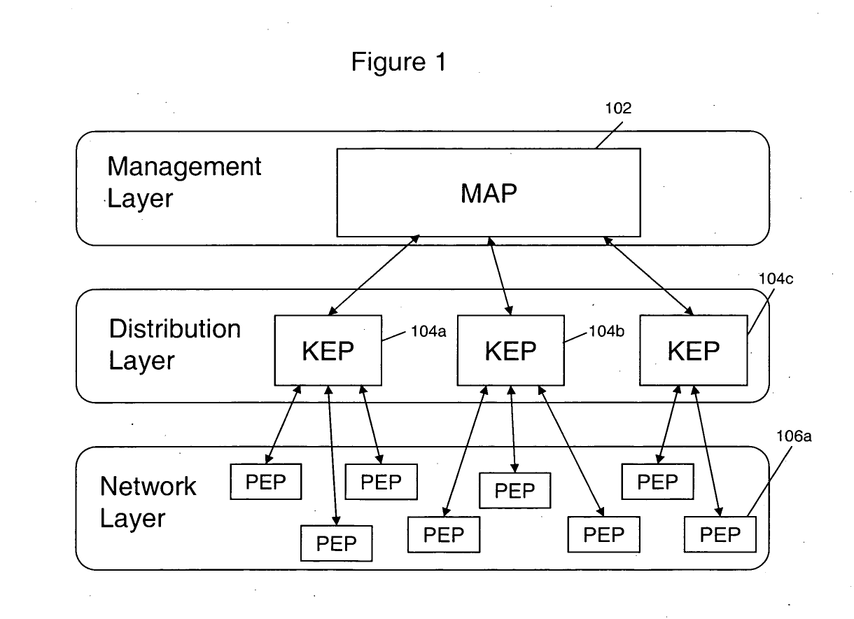

Referring now to the drawings in general, the illustrations are for the purpose of describing a preferred embodiment of the invention and are not intended to limit the invention thereto. FIG. 1 is a schematic showing a centralized software solution for providing and managing security for data and communications of a network in accordance with an embodiment of the present invention. This figure depicts hierarchical relationships between the MAP 102, KAPs 104 and PEPs 106. The arrows indicate communication between these elements and are not meant to depict data communication between nodes. MAP 102 stores and manages policies. The policies define the PEPs 106 that each of the KAPs 104 is responsible for. The policies also define which PEPs can be grouped together to form secure network sets. KAPs 104 are responsible for key generation and management for the PEPs 106 defined in the policies. The KAPs 104 manage the PEPs assigned to them based on the policies defined by MAP 102. The policies are pushed to the KAPs 104 by MAP 102. The PEPs that are hierarchically under MAP 104a can still communicate data with other PEPs not under the same KAP 104a. This is based on the policies defined by MAP 102. These arrows depict that KAP 104a is responsible for key generation and management for a smaller set of PEPs 106.

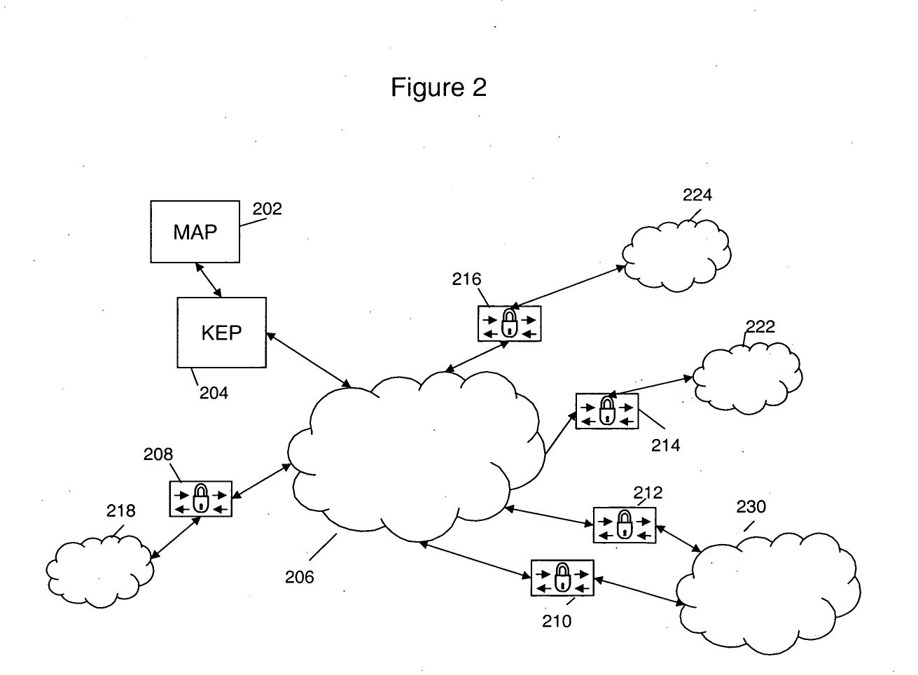

FIG. 2 is a schematic showing a plurality of PEPs distributed over a metro ethernet network to enable the formation of secure subnetworks, in accordance with an embodiment of the present invention. The figure shows MAP 202 operable to communicate with KAP 204. MAP 202 and KAP 204 can reside on the same computing device or can be in the form of two separate computing devices that are connected such that they can communicate with each other. KAP 204 is also connected to a metro ethernet network 206. Metro ethernet 206 is a network that covers a wide geographical area. It is commonly used to connect multiple subscribers to the internet and also to provide connectivity between branch offices of organizations that are separated geographically. The figure also depicts a multiplicity of PEPs 208, 210, 212, 214 and 216. PEPs 208-216 are operable to communicate with KAP 204 via the metro ethernet 206. KAP 204 can transmit cryptographic keys to PEPs 208-216 and other information relating to policies, such as rules for establishing secure associations between PEPs 208-216 and other elements of metro ethernet 206, that are pushed down by MAP 202. PEPs 208-216 are in turn connected with one or more subnetworks or nodes, depicted as 218, 220, 222 and 224. Each of these can be a single node, a group of nodes that are networked or other computing devices, network devices such as storage devices and/or servers, cable set-top boxes, local intranets, etc.

In an embodiment, MAP 202 defines policies such that PEPs 208 and 216 are part of group 1, denoted by the oval. PEP 214 is part of group 2, denoted by the rectangle and PEPs 210 and 212 are part both groups 1 and 2, denoted by the oval and rectangle combination. Based on these policies KAP 204 generates two sets of cryptographic keys that are shared between PEPs 208, 210, 212, 216 and PEPs 210, 212, 214 respectively. Hence, two separate subnetworks are formed from this one large metro ethernet. Nodes on subnetwork 1 (group 1 made up of PEPs 208,210,212, and 216) can communicate with other nodes on the subnetwork. For example, nodes in 218 can communicate with nodes in 230 and 224 and vice versa. PEPs encrypt and authenticate traffic from any of the nodes in the subnetwork. For example, PEP 208 encrypts and authenticates traffic from node 218 that is being transmitted to any of the other nodes on subnetwork 1. The traffic is encrypted and authenticated with the help of keys received from KAP 204. PEP 216 receives the encrypted and authenticated traffic, uses its key to verify and decrypt the traffic and forwards the traffic to its node 224 to which the traffic was addressed. Because the Layer 2 header never changes during network transit, PEP 216 simply forwards the decrypted packet to its destination. PEP 208 does not modify the Layer 2 headers on the originating traffic which enables the traffic to be passed on to PEP 216 transparently. The use of encryption and authentication ensures that the traffic is secure as it passes over metro ethernet 206. This description and figure is meant for exemplary purposes. It will be apparent to one skilled in the art that the scope of the present invention is not limited to the number of nodes and groups as described in the above paragraphs. Such variations and modification have been left for the sake of conciseness.

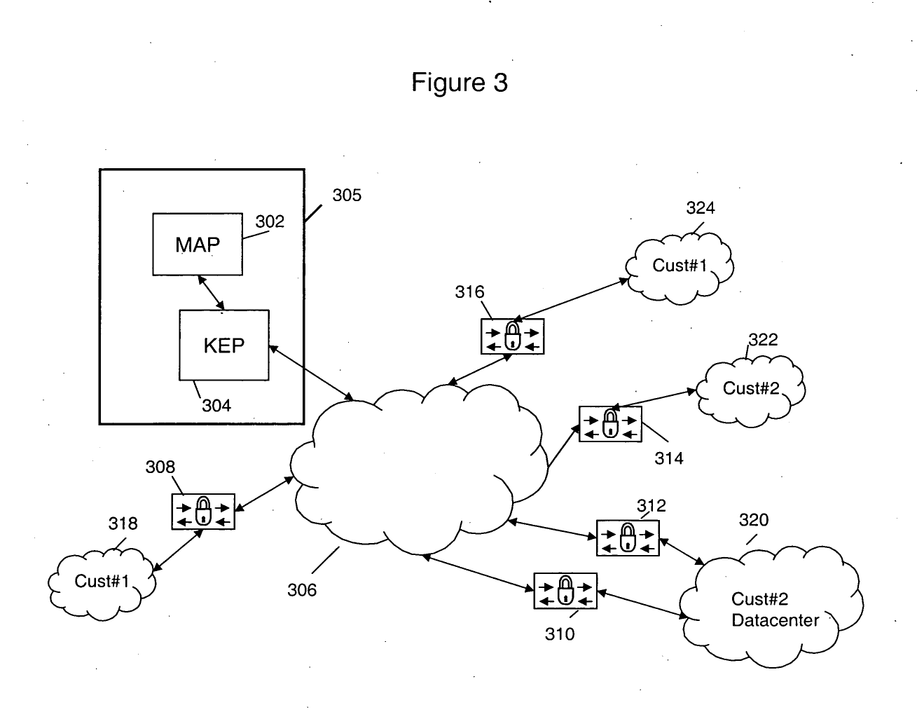

FIG. 3 is a schematic showing a plurality of PEPs distributed over a meshed network to enable the formation of secure subnetworks in conjunction with a central service provider, in accordance with an embodiment of the present invention. MAP 302 and KAP 304 are located at a common service provider's facility 305. KAP 304 is also connected to a metro ethernet network 306. The figure also depicts a multiplicity of PEPs 308, 310, 312, 314 and 316. PEPs 308-316 are operable to communicate with KAP 304 via the metro ethernet 306. KAP 304 can transmit cryptographic keys to PEPs 308-316 and other information, such as rules for establishing secure associations between PEPs 308-316 and other elements of metro ethernet 306, relating to policies pushed down by MAP 302. Nodes 318 and 324 represent networks of Customer #1 served by service provider 305. Nodes 320 and 330 represent networks of Customer #2 served by service provider 305. MAP 302 defines policies that enable nodes 318 and 324 to form a subnetwork and for nodes 330 and 322 to form another subnetwork. These policies can be set up on MAP. 302 by service provider 305. Policies are setup such that PEPs 308 and 316 share the same set of cryptographic keys, denoted by the oval and PEPs 310, 312 and 314 share another set of common cryptographic keys, denoted by the rectangle.

In such a meshed network, nodes belonging to the subnetwork of customer #1 can communicate to other nodes of the same customer. Data packets originating from any such node have Layer 2 addresses of the source and destination nodes. These packets are encrypted and authenticated by the corresponding PEP using the cryptographic key generated by the KAP. The Layer 2 headers of the packets are not modified by the PEP. The packets are delivered by the network using the Layer 2 address. The PEP at the receiving end recognizes the packets and uses its cryptographic key to authenticate and decrypt the packet. The Layer 2 address is then used to transmit the decrypted packet to the destination node.

In an alternate embodiment, the system of the present invention is used to provide secure distribution of broadcast or multicast content. Service provider 305 defines PEPs and corresponding nodes that are authorized to receive the content. Policies based on these definitions are sent to KAP 304. KAP 304 generates keys for the authorized PEPs. The PEP associated with the originating node encrypts and authenticates the content with the key received from KAP 304. Only authorized PEPs which have received the same key from KAP 304 will be able to decrypt the content and pass it on their respective nodes. Hence, subnetworks are formed that are authorized to view the broadcast or multicast content. These subnetworks can be changed by changing policies at MAP 302. These changes can be affected dynamically, manually or at predetermined intervals based on MAP 302.

Certain modifications and improvements will occur to those skilled in the art upon a reading of the foregoing description. By way of example, the number of MAPs, KAPs and PEPs can be varied. There can be one or more MAPs and/or KAPs in the network topology. Also, the system and method of the present invention can be used to address a variety of applications that require encryption and authentication, such as video broadcasting, content delivery using multicast, one to one security over unsecured networks. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A system for providing secure Layer 2 networks comprising:
a. a communication network having a network infrastructure; the communication network spread over a geography such that nodes on the network that communicate using Layer 2 protocols such as Ethernet are grouped at Layer 2,
b. at least one management and policy (MAP) server operable for communication within the network, wherein the MAP includes at least one policy for providing secure association (SA) within the network;
c. at least one key authority point (KAP);
d. a multiplicity of policy enforcement points (PEPs) having nodes distributed throughout the network;
wherein the KAP is operable to generate and manage key(s) communicated to the multiplicity of PEPs;
and wherein the multiplicity of PEPs enforce policies for secure communication between the nodes on the network and maintain transparency at Layer 2.

2. The system of claim 1, wherein a group selected from the multiplicity of PEPs share a common security policy as defined by the MAP.

3. The system of claim 2, wherein the group of PEPs share a common key.

4. The system of claim 3, wherein the common keys are changed after a predetermined time interval.

5. The system of claim 4, wherein the time interval is greater than 1 hour.

6. The system of claim 1, wherein the PEPs encrypt network traffic originating from the nodes connected to them using the key generated by the KAP.

7. The system of claim 1, wherein the PEPs decrypt network traffic destined to the nodes connected to them using the key generated by the KAP.

8. The system of claim 1, wherein the communication over the network to be secured is broadcast content.

9. The system of claim 1, wherein the communication over the network to be secure is multicast content.

10. A method for providing secure interactivity between points on a Layer 2 network comprising the steps of:
providing a communication network having a network infrastructure and a secure network topography between a multiplicity of policy enforcement points (PEPs) having nodes with any form of encryption associated therewith; the nodes spread over a wide geographic area such that they form a metro ethernet network over Layer 2;
a user providing at least one policy definition to a management and policy (MAP) server in communication with a key authority point (KAP);
the KAP generating and distributing at least one key to the PEPs consistent with the MAP policy;
the PEPs enforcing the policy at the nodes to provide secure communication across the network topography over the Layer 2 network.

11. The method of claim 10, wherein the MAP policy defines two or more PEPs to exchange data such that the nodes associated with the two or more PEPs can communicate transparently with each other.

12. The system of claim 11, wherein the two or more PEPs share a common cryptographic key.

13. The system of claim 12, wherein the common key is used to encrypt network traffic originating from one or more nodes associated with the two or more PEPs; the network traffic being transmitted to one or more other nodes associated with the two or more PEPs.

14. The system of claim 13; wherein the PEPs encrypt the network traffic to form encrypted frames which are transmitted between the two or more PEPs over the Layer 2 network.

15. A system for securing communication between at least two subnetworks that are spread over a geography, the system comprising:
a. a multiplicity of nodes grouped to form at least two subnetworks such that the communication between subnetworks is carried out at Layer 2;
b. a management and policy (MAP) server operable for communication with the at least two subnetworks, wherein the MAP includes at least one policy for providing secure association (SA) with the nodes on the subnetwork;
c. at least one key authority point (KAP) operable for communication with the MAP;
d. a multiplicity of policy enforcement points (PEPs); such that at least one PEP is associated with each of the at least one subnetworks;
wherein the universal KAP is operable to generate and manage key(s) communicated to the multiplicity of PEPs; and wherein the multiplicity of PEPs encrypt the communication between the subnetworks such that the encrypted communication is transported over Layer 2 transparently.
